(19) United States
(12) Patent Application Publication
(10) Pub. No.: US 2006/0145852 A1
(43) Pub. Date: Jul. 6, 2006

(54) Check-in system for traveling passengers

(75) Inventors: James McElhannon, Broken Arrow, OK (US); Brian McCormick, Tulsa, OK (US); Tony Eberle, Broken Arrow, OK (US)

Correspondence Address: OLIFF & BERRIDGE, PLC, P.O. BOX 19928, ALEXANDRIA, VA, 22320, US

(73) Assignee: ARINC Incorporated, Annapolis, MD (US)

(21) Appl. No.: 11/015,415

(22) Filed: Dec. 20, 2004

(51) Int. Cl. G08B 13/14

(52) U.S. Cl. 340/572.1

(57) ABSTRACT

A system and method for checking in ship-board passengers and their baggage for an airline flight includes issuing a valet receipt for the passenger prior to baggage check-in, to be replaced by the airline bag tag when the passenger is ready to hand over bags to baggage handling personnel.

### BACKGROUND OF THE INVENTION

1. Field of Invention

This invention relates to systems and methods for checking in passengers and baggage for a second mode of transportation, while still onboard a first mode of transportation. In particular, this invention is directed to checking passengers and baggage onto an airline flight, before arriving at the airport.

2. Description of Related Art

Many travelers enjoy ocean cruises for relaxation and vacation away from home and jobs. Most of these travelers travel to and from their homes to the port of embarkation by air. These passengers presently must carry their baggage for the trip by hand to and from the ship for transportation to and from the airport, and shepherd them along while waiting in line for check-in processing by airline personnel. During these traveling and waiting periods, their baggage is subject to loss, damage and theft, such that the passengers must be on constant guard over their baggage.

In general, such trips often involve more than one mode of transportation, such that passengers traveling with baggage must oversee the baggage as it is transferred between the modes of transportation. Often, this involves waiting in long lines before the baggage is transferred to the baggage handling service of the next mode of transportation. While waiting for check-in, the baggage is subject to loss, damage or theft.

### SUMMARY OF THE INVENTION

The invention described here is a method and apparatus for checking passengers and their baggage onboard one mode of transportation, for transfer to a second mode of transportation, before disembarking from the first mode of transportation. Exemplary embodiments of the invention are described in relation to air travel; however, it should be understood that the invention can be applied to any mode of transportation which includes a baggage handling service, such as ships, buses or trains.

Because of the possibility of loss, damage or theft to a passenger's baggage while underway, it would be advantageous to have a system wherein passengers transferring to a second mode of transportation, check their baggage in while still onboard the first mode of transportation. In particular, passengers bound to the airport can check their bags in at an earlier stage in their travel, en route to the airport, so that their baggage is secured earlier against loss, damage and theft.

For example, while onboard a ship and awaiting departure for a flight home, passengers are all congregated in one place from which they cannot travel. During this period, passengers are checked in for their flights home, and their baggage is identified with a tag corresponding to their boarding pass. Exemplary embodiments of the systems and methods thereby expedite the trip home, and relieve the passengers of having to stand in long lines at the airport to check into their flights and check their baggage.

Various exemplary embodiments of the systems and methods according to the invention can check in the passenger for the flight while still en route to the airport, to secure and transport the baggage to the airport baggage handling system, without oversight by the passenger.

In the exemplary embodiment described herein, passengers on a cruise, before disembarking from the cruise ship to travel to the airport for their return home, are checked into their return flights and their baggage is checked while the passengers are still on board the ship. Using this invention, passengers are relieved from having to oversee their baggage while using the various modes of transportation to finally arrive at the airport, and are relieved from having to wait in long lines to check into their flights and check their baggage.

According to various exemplary embodiments of the systems and methods according to this invention, at check-in, passengers are given a valet receipt for their baggage, by using a self-service kiosk onboard the ship. In other exemplary embodiments of this invention, the passengers are given a valet receipt for their baggage by using a manned baggage service desk. In still further exemplary embodiments of this invention, a boarding pass and valet receipt are delivered to the passenger's room at a later time, after the passenger has provided the information needed to check in, and has checked their baggage at the baggage service desk.

When the passenger is ready to give over their baggage to the baggage handling system, the valet receipt is converted to an airline bag tag. The bag tag, and a boarding pass having the corresponding bag tag information, are then printed. The airline bag tag is then affixed to the passenger's baggage, in place of the valet receipt.

Exemplary embodiments of the invention separately provide a check-in system which also has a bag tag reconciliation module, whereby the number of items actually given to the baggage handling system is reconciled with the number of items expected by the airline, based on the passenger's check-in information. If the two numbers do not match, the new number of checked items is transmitted to the airline, which either cancels a bag tag or issues an additional bag tag, whichever is appropriate. If necessary, the airline will issue a new boarding pass with the baggage information correctly printed on it.

These and other features and advantages of this invention are described in, or are apparent from, the following detailed description of various exemplary embodiments of the systems and methods according to this invention.

### BRIEF DESCRIPTION OF THE DRAWINGS

Various exemplary embodiments of this invention will be described in detail, with reference to the following figures, wherein:

FIG. 1 is a block diagram of an exemplary embodiment of a ship-board passenger and baggage check-in system according to this invention;

FIG. 2 is a block diagram showing greater detail of a self-service kiosk used to check the passenger in according to this invention;

FIG. 3 is a block diagram showing greater detail of the baggage service system according to this invention;

FIG. 4 is a flowchart outlining one exemplary embodiment of a passenger and baggage check-in method according to this invention;

FIG. 5 is a flowchart outlining in greater detail the enrollment and check-in steps of the method according to FIG. 4;

FIG. 6 is a flowchart outlining in greater detail the tag bags step of the method according to FIG. 4; and

FIG. 7 is a flowchart outlining in greater detail the reconcile tags step of the method according to FIG. 4.

### DETAILED DESCRIPTION OF EXEMPLARY EMBODIMENTS

This invention provides systems and methods for checking in a passenger and zero or more items belonging to the passenger, from a first mode of transportation to a second mode of transportation. The embodiment described herein pertains to a first mode of transportation being ship-board travel, and the second mode of transportation being air travel. However, it should be understood that this embodiment is exemplary only, and in no way limits the invention to the particular case of ship-board and air travel. Instead, the invention can be applied in any situation wherein passengers are being transferred between two different modes of transportation.

Furthermore, in various exemplary embodiments, the item belonging to the passenger may be a piece of the passenger's baggage. However, this invention can be applied to any item belonging to the passenger, including parcels, knapsacks, purses and the like.

In the exemplary embodiment described below, the passengers and zero or more bags are checked into their return flights while the passengers are still on board a cruise ship on which they have been traveling. Using the systems and methods according to this invention, passengers enroll in the service by inputting information required to check into the flight at a self-service kiosk or at a manned baggage service system desk located on board the ship. This check-in information is transmitted to a ship-board application server, and from there to an appropriate airline host, which accepts the information and responds with boarding pass information. The boarding pass information is queued for asynchronous transmission to the ship-board application server, which is in communication with the kiosk or the baggage service system on board the ship.

If the passenger is ready to check their baggage, airline bag tag identifiers are printed out at the baggage service system desk, and affixed to the passenger's bags by baggage handling personnel. A boarding pass can also be printed at this time, which includes information as to the bag tag identifiers affixed to the passenger's luggage by the baggage handling personnel.

Exemplary embodiments of this invention may include a bag tag reconciliation process. For example, if the number of bags checked does not match the number expected according to the information provided by the passenger at enrollment, the systems and methods according to this invention either cancel a bag tag or issue an additional bag tag in order to reconcile the number of bags expected by the system with the number of bags checked by the passenger.

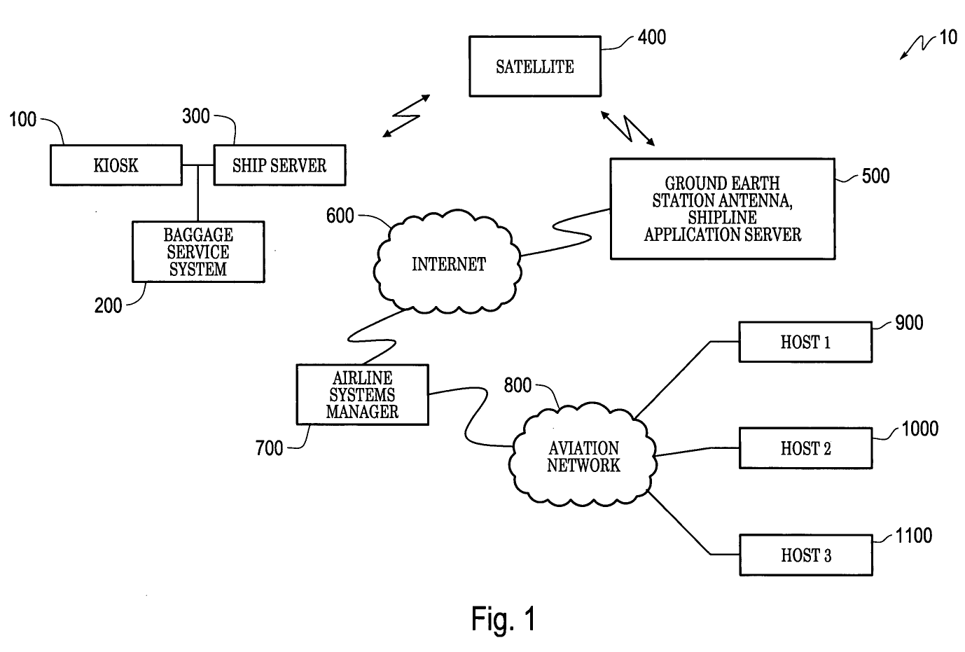

FIG. 1 shows a block diagram of an exemplary system 10 for implementing ship-board passenger and baggage check-in. The system 10 includes a self-service kiosk 100 and baggage service system 200, which are located either on board the ship or on the dock at the embarkation point. The self-service kiosk 100 or baggage service system 200 can be utilized by passengers either before departure or upon return.

The self-service kiosk 100 and baggage service system 200 are in communication with the ship's application server, for example, a ship server 300. The ship server 300 is an application server resident on the ship which provides data and business logic to the self-service kiosks 100 and baggage service systems 200. The ship server 300 is therefore an example of a “remote” computer, which is remote from the airport in that it is located a distance away from the airport, such as outside the perimeter of the airport buildings. The ship server 300 will communicate data input to the self-service kiosk 100 or baggage service system 200, for example, to terrestrial data networks via an orbiting satellite 400. Although not shown for simplicity, the ship server 300 therefore may include hardware required for communications with the orbiting satellite 400, such as a radio frequency unit which encodes data to be transmitted on an rf carrier wave, and a high power amplifier HPA, which amplifies the encoded rf wave before transmission to the orbiting satellite 400 by a ship-board antenna (also not shown).

A passenger may check into their return flight by entering required information, such as their name, flight number and departure city, at an information input system, such as the self-service kiosk 100. Alternatively, the passenger may check in at the manned baggage service desk of the baggage service system 200. The baggage service system 200 differs from the self-service kiosk 100 in being equipped to accept the passengers baggage, and to issue a boarding pass and bag tags to the passenger. Upon check-in using the self-service kiosk 100, the passenger inputs the expected number of bags into the system.

International passengers may be required to provide passport information to the self-service kiosk 100 or the baggage service system 200 at this point, unless the host is capable of storing this data from previous check-ins. The data may be input manually, or read by a passport reader.

The information input system, such as the kiosk 100 or baggage service system 200, then transmits the check-in information to the ship server 300, which transmits the information via satellite 400 to a ground-earth station antenna/shipline application server 500. The ground-earth station antenna/shipline application server 500 is in communication, for example, via the Internet 600, with an airline systems manager 700. To establish a session between the ship server 300 and the airline systems manager 700, the data may therefore traverse several different networks that are operated by different vendors. The data may use different media such as wired communications, satellite, and microwave, as it travels across the session. Given the public nature of the Internet 600, the data should in general, be encrypted prior to its transmission. Firewall functionality is generally provided on the ship server 300 and the airline systems manager 700 to add security features such as Network Address Translation (NAT), and packet filtering, although for simplicity, this component is not shown in FIG. 1. It is also assumed that this firewall implements a virtual private network.

The airline systems manager 700 includes hardware and software for translating queries into a format understandable by host computers 900, 1000, and 1100. The host computers 900, 1000, and 1100 are mainframe computers that offer extremely high throughput and resilience. Each mainframe 900, 1000 and 1100 is owned and operated independently by an individual airline carrier. In general, each host computer 900, 1000, and 1100 operates using its own grammar and protocols, such that a central resource, such as the airline systems manager 700, is required to translate a query coming from an individual client computer, such as the self-service kiosk 100, into a format understandable by the host computers 900, 1000, and 1100.

The host computers 900, 1000 and 1100 are connected via a transportation network, such as an aviation network 800, such as that operated by ARINC of Annapolis, Md. The aviation network 800 is a communications network which provides communications pathways between the various host computers 900, 1000 and 1100. In order for the computers to communicate with one another, their requests must be translated from the protocol associated with a source computer, such as computer 900, with a target computer, such as computer 1000 or 1100. In addition, the aviation network 800 provides a communications pathway between the client computer, such as the self-service kiosk 100, and the host computers 900, 1000, and 1100. The protocol associated with a request from a client computer must be translated into a format understandable by the host computer 900, 1000 or 1100. The airline systems manager 700 provides this functionality, and may be operated by the same entity that operates the aviation network 800. Therefore, the airline systems manager 700 transmits the check-in request and check-in data, provided by the passenger at the self-service kiosk 100 or the baggage service system 200, to the target host computer 900, 1000 or 1100 after translating the request into the format appropriate for the target host computer 900, 1000 or 1100.

The general flow of data is shown in FIG. 1. As described previously, the passenger may input data using, for example, a self-service kiosk 100 or a baggage service system 200. The data moves from where it is input into a message queue in the ship server 300. The data waits in ship server 300 until there is connectivity across the satellite link to the ground earth station antenna/shipline application server 500. When connectivity is present, the data moves to the ground earth station antenna/shipline application server 500. Once in the ground earth station antenna/shipline application server 500, the data waits until there is connectivity across the Internet 600. Once there is connectivity, the data moves to the airline systems manager 700.

If along this entire path connectivity has been available, the entire transmission takes only a few seconds. If connectivity is only intermittently available, the transmission will take longer. In the worst case, the complete transmission may take several days.

Once the data is in airline systems manager 700, the data will be examined to determine its carrier and flight. Each carrier will have its own processing rules about how far in advance a flight may be checked in for. This is known as the “check-in horizon”. For example, the three carriers corresponding to host computers 900, 1000 and 1100 may have the following rules:

TABLE

| Host | Max advanced check in time |
|---|---|
| Host 1 900 | 24 hours |
| Host 2 1000 | 36 hours |
| Host 3 1100 | 18 hours |

When a message arrives in airline systems manager 700, if the message is for a carrier that is operated by Host 1 900, for example, then the departure time for the flight is looked up. If the check-in time is within the Host 1 900 check-in horizon, then the check-in request is allowed to proceed. If the check-in time is outside of the check-in horizon, the check-in cannot be processed at this time, and the check-in request is not transmitted to the Host 1 900. If the check-in request is outside the check-in horizon, a reminder alarm is set that will go off to provide notification that it is time to process the check-in request later.

For messages in airline systems manager 700 that do get sent to the host, the host responses are processed, the host data parsed and normalized, and the response message is returned to the airline systems manager 700. When connectivity across the Internet is available to the airline systems manager 700, the message is moved from the airline systems manager 700 to the ground earth station antenna/shipline application server 500. When connectivity is available across the satellite from the ground earth station antenna/shipline application server 500 to the ship server 300, the messages are moved to the ship server 300. Once in the ship server 300, the message is accessible to the primary ship applications, the self service kiosk 100 and the baggage service system 200.

If the check-in request is within the check-in horizon, the host computer 900, 1000 or 1100 responds to the input data by issuing, for example, a boarding pass. The airline systems manager 700 interprets this response, and translates it into a format which is understandable by the client computer, such as the self-service kiosk 100 or the baggage service system 200. The boarding pass information is then transmitted back to the aviation network 800, back to the airline systems manager 700, through the Internet 600 to the ground-earth station antenna/shipline application server 500. The ground-earth station antenna/shipline application server 500 may transmit the data asynchronously to the satellite 400 and then to the ship server 300. In the event that the communications connection between the ground-earth station and the ship is momentarily unavailable, the data can be stored at the airline systems manager 700 before transmission to the ship server 300. The data can then be transmitted when the communications link becomes available. The boarding pass data may be stored by the ship server 300, until the passenger has checked in their baggage, as described further below.

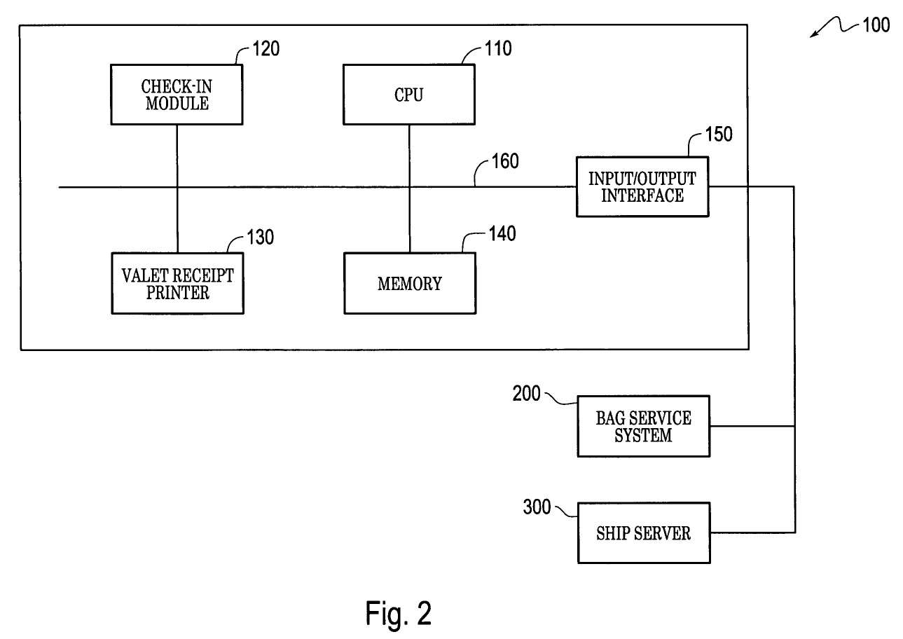

FIG. 2 shows greater detail of an exemplary embodiment of the self-service kiosk 100, usable in the system of FIG. 1. The self-service kiosk 100 may include a CPU 110, a check-in module 120, a valet receipt printer 130, memory 140, and an input/output interface 150. The aforementioned components may be coupled together using, for example, a bus 160. While the self-service kiosk 100 is illustrated using a bus architecture diagram, any other type of hardware and/or software configuration may be used. For example, application specific integrated circuits (ASICs) may be used to implement one or more of the components, or a computer program that executes in the CPU 110 may be used to perform one or more of the functions of the self-service kiosk 100.

A passenger may input information to the self-service kiosk using a touch screen coupled to the input/output device. Alternatively, the information can be read from a personally encoded ID card provided by the cruise line, which stores information such as the passenger's name and room number on a magnetic stripe. Similar functionality can also be provided if the ID cards are encoded with a bar code and if the kiosk is equipped with a bar code scanner.

Additional information may be input in response to questions posed to the passenger by the check-in module 120. The questions may include the passenger's flight information, and the expected number of bags that the passenger will be checking in. Upon satisfactorily answering the questions, the information is stored in memory 140, and the self-service kiosk may print out a valet receipt for the passenger's baggage, via the valet receipt printer 130. The valet receipt may be accompanied by tags with adhesive backing which can be affixed to the passenger's bags, indicating that the passenger has enrolled in the service. The valet tags will be replaced by International Air Transport Association (IATA) bag tags when the passenger's boarding pass is printed, as described further below.

The self-service kiosk 100 then transmits the check-in information to the ship server 300, which queues the information to be asynchronously transmitted to the airline systems manager 700, via the satellite 400, the ground-earth station antenna/shipline application server 500, and the Internet 600. Upon receipt by the airline systems manager 700, the information and check-in request will be translated into a host command recognizable by the host 900, 1000 or 1100. If there is presently no link to the target host machine 900, 1000 or 1100, the information remains queued until a connection is established. Upon receipt of the request and check-in information, the host 900, 1000 or 1100, responds with the requested boarding pass information, and transmits it to the airline systems manager 700. The airline systems manager 700 then acknowledges receipt of the boarding pass information and queues the information to be sent asynchronously to the ship server 300. The airline systems manager 700 then requests the specified number of bag tags from the host computer 900, 1000 or 1100. The airline systems manager 700 then acknowledges receipt of the bag tag information, and queues the information to be sent asynchronously to the ship server 300.

Numerous other embodiments are contemplated for enrolling passengers in the service. For example, the passenger can enroll at the baggage service system desk 200, described more fully below. Alternatively, the passenger can enroll when booking the cruise ship voyage. The passenger could also enroll via an on-board interactive voice response system. That is, using a touch-tone phone, the passenger could input the number of expected bags to the interactive voice response system, and any additional information could be obtained by having baggage handling personnel visit the passenger's room. The interactive voice response system could also include a component which is capable of answering calls, assembling pre-recorded speech fragments into logical phrases that are spoken to the passenger, obtaining information via the telephone keypad, and transferring the information to the ship server 300.

Finally, the passenger could enroll via an intelligent television application, wherein the application provides an on-screen method of entering the needed information. A component of the intelligent television application will also display prompts on the passenger's TV screen and process the input given to the application by the passenger using the TV remote control, or, if so equipped, an in-room wireless keyboard. The component then transmits the information to the ship server 300.

Using any such means as described above, inputting the appropriate information, transmitting the information to the host via the ship server 300, and generating the valet receipt completes the enrollment phase of the method. The passenger is advised that his travel documents will be delivered to his room a short time after the baggage service system 200 takes possession of his bags.

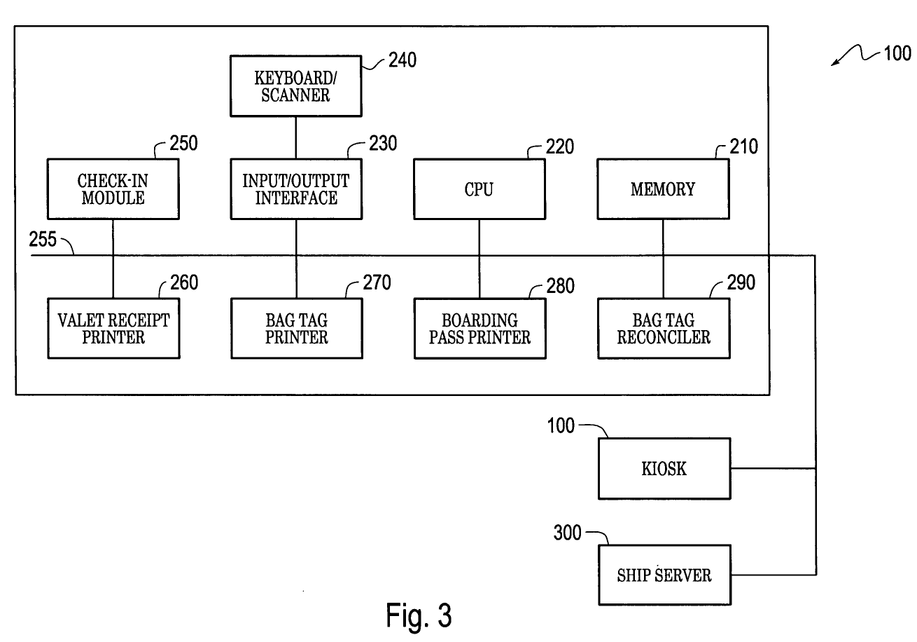

In order to complete the check-in process and receive a boarding pass, the passenger may proceed to the baggage service system 200 desk. An exemplary embodiment of the baggage service system 200 is shown in greater detail in FIG. 3. The baggage service system 200 may include a memory 210, a CPU 220, an input/output interface 230 connected to a keyboard 240, a check-in module 250, a valet receipt printer 260, a bag tag printer 270, a boarding pass printer 280, and a bag tag reconciler 290. The aforementioned components may be coupled together via a bus 255. While the baggage service system 200 is illustrated using a bus architecture diagram, any other type of hardware and/or software configuration may be used. For example, application specific integrated circuits (ASICs) may be used to implement one or more of the components, or a computer program that executes in the CPU 220 may be used to perform one or more of the functions of the baggage service system 200.

At the baggage service system 200 desk, the passenger may exchange the valet receipt bag tags for actual IATA bag tags, which are affixed to the bags by baggage handling personnel. The number of the valet tag from the passenger may be entered using the keyboard or bar code scanner 240. The valet number is transmitted to the ship server 300 via the input/output interface 230. The ship server 300 retrieves the bag tag information received from the airline systems manager 700, which corresponds to the valet number. The ship server 300 transmits the bag tag information to the baggage service system 200, which prints the IATA bag tag on the bag tag printer 270. After the baggage handling personnel have custody of the bags, the valet tag is removed and replaced with an IATA bag tag. The baggage service system 200 then queues a message to the airline system manager 700 that the bag has been processed.

An aspect of this invention is that the IATA bag tags are only printed out and affixed to the passenger's bags after the passenger has given over the bags to the baggage handling personnel. Bag tag printing can occur in three ways: (a) all bag tags are printed on the ship, no bag tags are printed on the dockside; (b) bag tags are printed both on the ship and on the dockside; and (c) no bag tags are printed on the ship, all bag tags are printed dockside. However, in any case, the bag tags are only printed out after the baggage handling personnel have taken possession of the bags. This aspect is to address security concerns regarding the printing of bag tags in advance of the bags being secured. Using the systems and methods according to this invention, the airline host is requested to transmit bag tag information as it normally would for a checked bag. However, the system will store the information until such time as the bags are physically in the control of the baggage handler. At this point, the system will retrieve the bag tag information and physically print the bag tag.

In the event that the passenger presents a number of bags to the baggage service system which differs from the number submitted at enrollment, the bag tag reconciler 290 proceeds with a bag tag reconciliation routine. The valet receipt number is entered to retrieve the number of bags expected, according to the number entered at enrollment. The number of actual bags that the passenger wishes to check is then input. The bag tag reconciler 290 then forms the necessary command, either a bag tag issue request or a bag tag cancel request, and transmits the command to the ship server 300 via the input/output interface 230. The ship server 300 stores the request and also forwards the request to the airline system manager 700. The airline system manager 700 translates the request into a host command, and forwards the host command to the appropriate host 900, 1000 or 1100, via the aviation network 800. The host computer 900, 1000 or 1100 then responds with either a confirmation of the bag tag cancellation or with the new bag tag information. If the bag tag operation causes a new boarding pass to be required, the boarding pass information will be generated at this time as well. The airline system manager 700 then transmits the new response to the ship server 300, which transmits the response to the baggage service system 200. The new bag tag information is printed out on the bag tag printer 270, and the new boarding pass is printed out on the boarding pass printer 280. The boarding pass with bag tag receipts is then delivered to the passenger.

If the communications link between the ship server 300 and the airline system manager 700 is temporarily unavailable, the request for tag addition or cancellation can be stored on the ship server 300 and transmitted asynchronously to the airline system manager 700 at a later time. In this case, the ship server 300 acknowledges receipt of the bag issue or cancel request to the baggage service system 200, and the acknowledgement is displayed on the user's screen at the baggage service system 200. At the later time when the request is transmitted to the airline system manager 700, the airline system manager 700 then forms the request in a format appropriate for the target host computer 900, 1000, or 1100. The host 900, 1000 or 1100 then responds with the appropriate information which is transmitted asynchronously to the ship server 300.

It should be appreciated that, in various exemplary embodiments, the self-service kiosk 100 and baggage service system 200 can be implemented as software executing on a programmed general purpose computer. Likewise, the self-service kiosk 100 and baggage service system 200 can also be implemented on a suitably equipped computer, a programmed microprocessor or microcontroller and peripheral integrated circuit elements, an ASIC or other integrated circuit, a digital signal processor (DSP), a hardwired electronic or logic circuit, such as a discrete element circuit, a programmable logic device, such as a PLD, PLA, FPGA or PAL, or the like. In general, any device that is capable of implementing the functionality disclosed herein can be used to implement the self-service kiosk 100 and baggage service system 200. Each of the various signal lines outlined above in FIGS. 1-3 connecting the various modules and the like can be direct signal line connections or can be software connections implemented using an implication programming interface or the like. It should be appreciated that any appropriate hardware, firmware or software elements or data structures can be used to implement one or more of the various modules and/or signal lines outlined above with respect to FIGS. 1-3.

It should be understood that each of the elements described above may comprise circuits, routines, applications, modules or the like, and may be implemented as software that is stored on a computer-readable medium and that is executable on a programmed general purpose computer, a programmed special purpose computer, a programmed microprocessor, a programmed digital signal processor or the like. Such a computer-readable medium includes using a carrier wave or the like to provide the software instructions to a processing device. It should also be understood that each of the circuits, routines, applications, modules or the like may be implemented as portions of a suitably programmed general purpose computer. Alternatively, each of the circuits, routines, applications, modules or the like may be implemented as physically distinct hardware circuits within an ASIC, using a digital signal processor DSP, using an FPGA, a PLD, a PLA and/or a PAL, or using discrete logic elements or discrete circuit elements. The particular form of the circuits, routines, applications, modules or the like is a design choice. It should be appreciated that the circuits, routines, applications, modules or the like do not need to be of the same design.

The terms “circuit”, “routine”, “application”, and/or “module” can refer to, for example, any appropriately-designed circuit, a sequence of instructions, a sequence of instructions organized with any programmed procedure or programmed function, and/or a sequence of instructions organized within programmed processes executing in one or more computers. Such circuits, routines, applications, modules, or the like, can also be implemented directly in circuitry that performs a procedure. Further, the data processing described with respect to FIGS. 1-3 can be performed by a computer executing one or more appropriate programs, by special purpose hardware designed to perform the method, or any combination of such hardware, firmware and software elements.

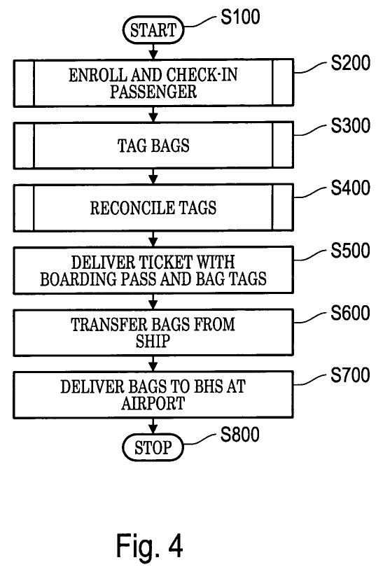

Although the previous description has been given with reference to a hardware embodiment, as mentioned above, the method may also be implemented as software executing on a microprocessor. In this case, each of the steps of the method may be carried out by a programmed microprocessor or ASIC, or it may be performed by some combination of hardware and software executing the steps of the method. The overall process exemplified by FIG. 1 can be performed by one or more microprocessors executing the exemplary steps shown in FIG. 4.

FIG. 4 is an exemplary flowchart illustrating the process of checking in passengers and baggage on board a ship, for a airline flight.

According to FIG. 4, the process starts in step S100 and proceeds to step S200, where the passenger is enrolled and checked in. In step S300, the passenger's bags are tagged. In step S400, the number of bags presented by the passenger for checking is reconciled with the number of bags expected based on the valet receipt. In step S500, the ticket, along with boarding pass and bag tag information, is delivered to the passenger. In step S600, the bags are off-loaded from the ship and onto a truck for transportation to the airport. In step S700, the bags are delivered by the truck to the baggage handling service (BHS) at the airport. The process ends in step S800.

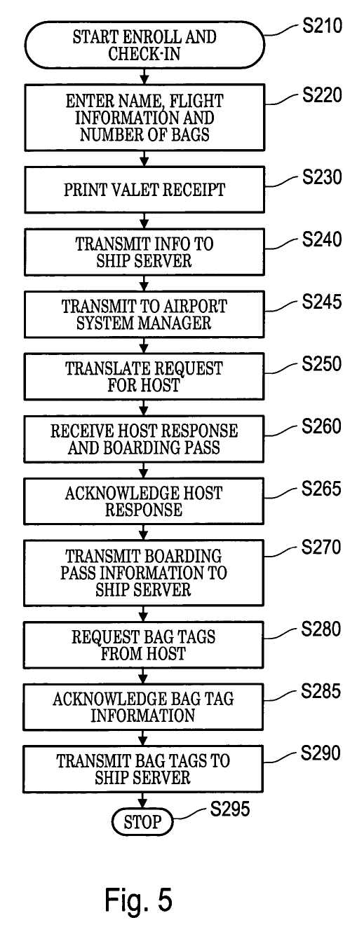

FIG. 5 shows additional detail of an exemplary process for enrolling and checking in passengers. This process corresponds to step S200 of FIG. 4. In step S210, the enrollment procedure begins and continues to step S220. In step S220, the passenger's name, flight information, and number of bags to be checked are input to the system. If performed on the self-service kiosk, the information may be input by the passenger using the kiosk keyboard or touch screen. In step S230, the valet receipt for the passenger is printed. In step S240, the inputted information is transmitted from the self-service kiosk or baggage service system to the ship server. In step S245, the information is transmitted to the airline system manager. In step S250, the airline system manager translates the request into the appropriate format to be understood by the host. In step S260, the response from the host is received by the airline system manager. In step S265, the airline system manager acknowledges receipt of the host response. In step S270, the boarding pass information in the host's response is transmitted to the ship server. In step S280, a request for bag tags is made to the host by the airline system manager. In step S285, the airline system manager acknowledges receipt of the host's response to the bag tag request. In step S290, the airline system manager transmits the bag tag information to the ship server. The process then ends in step S295.

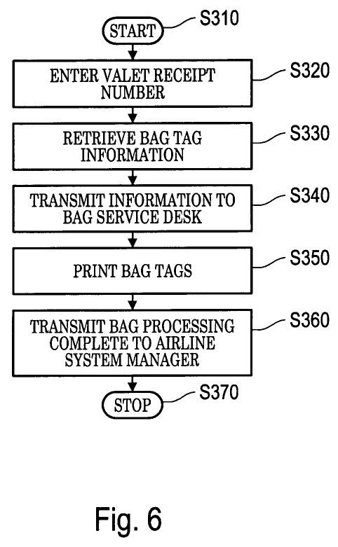

FIG. 6 shows additional detail of an exemplary process for tagging the bags. The process corresponds to step S300 of FIG. 4. The process begins in step S310 and continues to step S320, where the valet receipt number is entered. The valet receipt number may be entered by typing on a keyboard, or by scanning the valet receipt with a bar code scanner. The bag tag information corresponding to the valet receipt number is retrieved from the ship server in step S330. In step S340, the bag tag information is transmitted to the bag service system desk. The bag tags are then printed out in step S350 at the baggage service system desk by the bag tag printer, and affixed to the passenger's bags. A bag processing complete message is then transmitted to the airline system manager in step S360. The process ends in step S370.

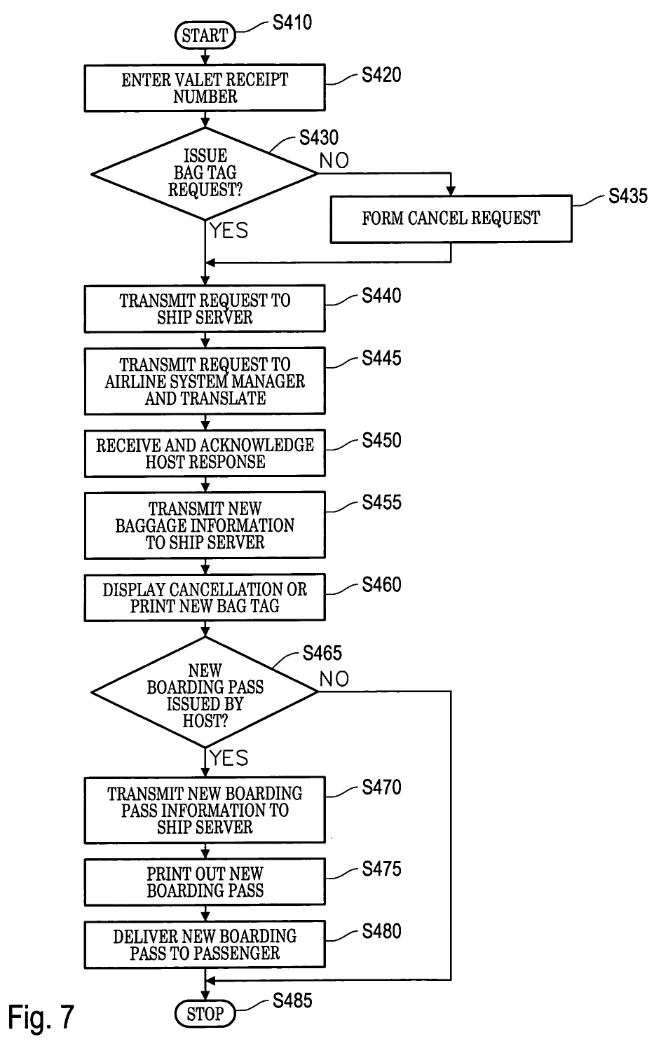

FIG. 7 shows additional detail of an exemplary process for reconciling bag tags. This process corresponds to step S400 of FIG. 4. This process is used when the passenger presents a different number of bags for checking in, than the passenger entered upon enrollment with the service. The process begins in step S410, and proceeds to step S420, where the valet receipt number is entered. The valet receipt number can be entered at a keyboard, or it can be entered by scanning a bar code printed on the valet receipt. A determination is made in step S430, whether a bagtag issue request should be made, depending on the number of bags presented by the passenger. If so, the process proceeds to step S440, wherein the bagtag issue request is transmitted to the application server. If not, a cancel request is formed in step S435, and the cancel request is transmitted to the ship server in step S440. The ship server stores the issue or cancel request and forwards the request to the airline system manager in step S445. In step S445, the airline system manager translates the request into a format appropriate for the target host computer, and transmits the request to the target host computer. In step S450, after receiving the host response, the airline system manager acknowledges the host response. The airline system manager then transmits the new baggage information to the ship server in step S455. The baggage service system then displays the cancellation or prints a new bag tag in step S460. A determination is then made in step S465, whether the bag tag request requires the issuance of a new boarding pass. If not the process ends in step S485.

If the bag tag request did require the issuance of a new boarding pass, the new boarding pass information is transmitted to the ship server in step S470. In step S475, the baggage service system prints out the new boarding pass. In step S480, the new boarding pass is delivered to the passenger, and the process ends as before in step S485.

While this invention has been described with respect to a particular embodiment, that of passengers traveling on a cruise ship, it should be understood by one skilled in the art that this invention may be applicable to other scenarios as well. For example, the invention could be useful for travelers traveling by train or bus.

Wherever large enough groups of people gather on route to a departure location, such that their number warrants the deployment of a kiosk and/or baggage service system, the system as described above can be implemented to check their baggage prior to their arrival at the departure location. For example, subway stations could be equipped with kiosks and/or baggage service systems to check passengers and bags onto flights before the passengers actually travel to the airport. By checking their baggage earlier along their transportation route, the travelers are relieved from having to carry and otherwise monitor their personal possessions while en route to the airport.

While this invention has been described in conjunction with the exemplary embodiments outlined above, it is evident that many alternatives, modifications and variations will be apparent to those skilled in the art. Accordingly, the exemplary embodiments of the invention as set forth above are intended to be illustrative, not limiting. Various changes may be made without departing from the spirit and scope of the invention.

What is claimed is:

1. A method for checking in a passenger from a first mode of transportation to a second mode of transportation, comprising:
inputting passenger information and check-in request into an information input system located a distance away from the departure location of the second mode of transportation;
transmitting the input passenger information and the check-in request to a remote computer located a distance away from the departure location of the second mode of transportation;
transmitting the input passenger information and check-in request from the remote computer to a transportation network;
transmitting the input passenger information and check-in request to a host computer connected to the transportation network; and
receiving a response from the host computer, at the information input system.

2. The method of claim 1, further comprising:
translating the input passenger information and the check-in request into a format understandable by the host computer.

3. The method of claim 1, further comprising:
issuing a valet receipt for at least one item belonging to the passenger.

4. The method of claim 1, wherein the transportation network is an aviation network, and the host computer is an airline host computer.

5. The method of claim 3, wherein the valet receipt is printed by the information input system.

6. The method of claim 1, further comprising:
translating the response from the host computer into a format understandable by the remote computer; and
transmitting the translated response to the remote computer.

7. The method of claim 3, further comprising:
exchanging the valet receipt for a bag tag when the passenger provides the at least one item to a baggage service system.

8. The method of claim 7, further comprising:
reconciling a number of items provided to the baggage service system with a number of items expected based on the input passenger information and the check-in request.

9. The method of claim 8, further comprising:
at least one of canceling a bag tag request and requesting an additional bag tag based on the reconciling step.

10. The method of claim 9, further comprising:
receiving boarding pass information from the host computer, by the remote computer.

11. The method of claim 10, further comprising:
printing out a boarding pass and a bag tag for the passenger and the at least one item belonging to the passenger, when the passenger provides the at least one item to the baggage service system.

12. The method of claim 1, wherein the remote computer is located on board a ship.

13. The method of claim 12, wherein the input information is transmitted from the remote computer to the transportation network via a satellite.

14. The method of claim 1, wherein the information input system comprises at least one of a self-service kiosk, a baggage service system, an interactive voice response system and an intelligent television channel.

15. The method of claim 12, further comprising:
providing at least one item to a baggage service system;
printing out a boarding pass and a bag tag at the baggage service system when the at least one item has been provided to the baggage service system; and
affixing the bag tag to the at least one item.

16. An apparatus for checking in a passenger for passage on a mode of transportation, comprising:
an information input system located at a site a distance away from a departure location of the mode of transportation, for inputting check-in information;
a baggage service system located at a site a distance away from the departure location of the mode of transportation, for obtaining item information and for securing at least one of the passenger's items; and
a remote computer in communication with a transportation network, for transmitting the check-in information and item information to the transportation network.

17. The apparatus of claim 16, wherein the transportation network is an aviation network.

18. The apparatus of claim 16, wherein the baggage service system further comprises:
a bag tag reconciler for reconciling a number of items input as check-in information with the number of items secured by the baggage service system.

19. The apparatus of claim 16, wherein the baggage service system further comprises:
a bag tag printer; and
a boarding pass printer.

20. The apparatus of claim 16, wherein the transportation network provides communications pathways between host computers belonging to different airlines.

21. The apparatus of claim 16, wherein the information input system further comprises:
a valet receipt printer.

22. The apparatus of claim 16, further comprising:
a transportation systems manager which manages communications between host computers communicating on the transportation network.

23. The apparatus of claim 22, wherein the remote computer transmits check-in information and item information to the transportation systems manager.
